(19) United States
(12) Patent Application Publication
(10) Pub. No.: US 2005/0193347 A1
(43) Pub. Date: Sep. 1, 2005

(54) Method and system for storing and presenting personal information

(75) Inventor: Bert Van Dam, Apeldoorn (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Koninklijke KPN N.V.

(21) Appl. No.: 11/062,407

(22) Filed: Feb. 22, 2005

Related U.S. Application Data
(63) Continuation of application No. 60/548,688, filed on Feb. 27, 2004.

(51) Int. Cl. G06F 3/00; G06F 17/24; G09G 5/00

(52) U.S. Cl. 715/764; 715/762; 715/733; 715/751; 715/747; 715/745; 715/523; 345/632

(57) ABSTRACT

A method of enabling users to make personal information available through a public world-wide communication system is disclosed. The method includes presenting the user a predetermined easy and intuitive user interface, enabling the user to fill in his personal information, and enabling other people to have access to said personal information through said easy and intuitive user interface. The personal information can comprise different formats and can stay available for access long after the user has deceased, even for eternity.

### CROSS-REFERENCE TO RELATED APPLICATION

The present patent application claims priority under 35 U.S.C. § 119(e) to U.S. Provisional Patent Application Ser. No. 60/548,688, filed on Feb. 27, 2004, the entirety of which is herein incorporated by reference.

### FIELD OF INVENTION

The present invention relates to a method of enabling users to make personal information available through a public world-wide communication system. The invention further relates to a computer program product for causing a processor to perform the method. The invention also relates to a communication system for making personal information of a user available to other users, where the system includes a server and a plurality of client stations arranged for communication through a world-wide communication network.

### BACKGROUND

People have diverse primary needs, such as eating, drinking, sleeping, feeling secure, love, etc. One of such needs is also to be appreciated by other people. As part of this, people have an urge to share personal information with other people and a need to determine a personal legacy in such a way that it is able to make accessible ones personally determined personal information for eternity, long after one has deceased. With the success of Internet, people have also started using this medium to share personal information with the world-wide Internet community. One way of doing this is through personal web-sites. Developing and maintaining such web-sites, however, is too complicated and too time-consuming for many people. Moreover, searching and browsing through personal web-sites is difficult and time-consuming. It is thus desirable to have a more uniform way of storing and making available of personal information through the Internet.

U.S. Pat. No. 6,340,978 discloses a system that provides on-line access (for instance through the Internet, direct connection, etc.) to the family life story of people that have stored such a story. The story may be stored in a ‘memory tube’ with a non-degradable storage, such as a non-volatile computer-readable medium. The family life story is accessible after the person has deceased. The non-volatile memory is intended to allow timeless preservation of family information. A communication line links to the memory tube enabling retrieval of the stored information. U.S. Pat. No. 6,340,978 also discloses a user interface on a computer system displaying the stored information after the user has identified the memory tube. The system does not provide a simple user interface for browsing through information without knowing the identifiers. Although, the information that is stored may be personal, the primary interface is basic and impersonal.

### SUMMARY

To meet an object of the invention, a method of enabling users to make personal information available through a public world-wide communication system is disclosed. The method includes presenting the user an easy and intuitive user interface, and enabling the user to fill in his personal information, enabling other people to have access to said personal information through said easy and intuitive user interface. This has one advantage that personal information with regard to a lot of people, from all over the world, can be stored and accessed in one place, which provides a friendly and familiar user interface. To make it easy to fill in and access the information, the user is preferably presented with a predetermined fixed format, to fill in his information. In this way, the presentation of the personal information is the same for all users. The personal information can be stored in different formats, like text for more factual information and life stories, for example. But, also favorite musical fragments, pictures, or even video sequences can be used to present a personality.

Preferably, the system enables storage of the information for a long time, also after the user has deceased, even for eternity. In this way, a personal memory of a user exists long after his death. To keep and maintain the information for a longer time, the method comprises the possibility of converting said personal information to other existing or newly developed data formats. According to an embodiment of the method, the user has to pay a fee to be enabled to enter his personal information. Part of this fee can be invested to enable maintenance over a long period of time. In this way, a provision is made for ensuring that the personal information can also be made available after death of the user, without requiring further payments by heirs.

In yet another embodiment, the user interface presents a 2 or 3 dimensional virtual landscape, enabling the user to select a spot in said landscape and to store personal information in association with the selected spot. Selecting spots on a graphical area and linking the personal information to such a spot is a simple and intuitive user interface that can easily be understood also by novices to computer systems and Internet. In this way, the interface of the system enables a user to select a spot in a part of the area that suits the user. For example, a person liking classical gardens can select a spot in such a garden. A person liking mountaineering may select a spot on a mountain. A person who is fond of sailing may select a spot located on a lake or sea, etc.

In still another embodiment, a communication system for making personal information of a user available to other users is disclosed. The system includes a server and a plurality of client stations arranged for communication through a world-wide communication network. The server comprises means for displaying an easy and intuitive user interface to the user, means for receiving personal information from the user in the form of text, pictures, sound and moving images, and means for keeping and maintaining said personal information long after the user has deceased.

### BRIEF DESCRIPTION OF THE DRAWINGS

In the drawings:

FIG. 1 conceptually illustrates a planet as part of an example system according to one embodiment.

FIG. 2 shows an example of a start page for a system according to one embodiment.

FIG. 3 shows an example of a web page for an area map.

FIG. 4 shows an example of a web page for an active or closed spot.

FIG. 5 shows one embodiment of a flow chart for checking whether a spot owner is still alive.

FIG. 6 shows an exemplary block diagram of a system according to one embodiment.

### DETAILED DESCRIPTION

Hereinafter some examples of systems according to the invention are described. It will be appreciated that a virtually unlimited number of different embodiments could be realized, without parting from the scope of the invention. The features described hereinafter are included to illustrate rather than limit the invention.

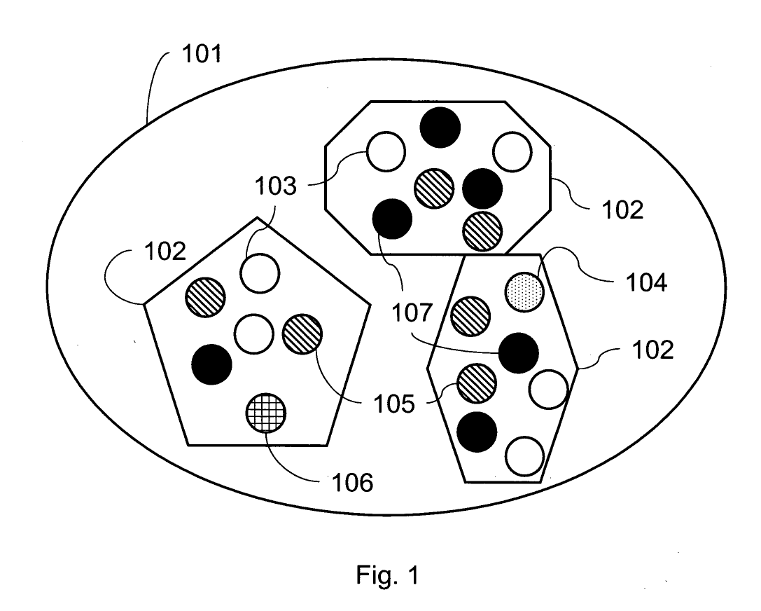

FIG. 1 schematically shows a planet 101 as part of a system according to the invention. The planet 101 comprises at least one area 102. It will be appreciated that the planet is a virtual planet. The planet may be represented by a graphical representation of an actual planet but may also be a creating of an artist or composed of photos. Multiple areas 102 may be interconnected with or be isolated from each other. An area 102 comprises spots. An area 102 may be presented as an environment or landscape. Spots are situated in said landscape. Some users of the system may, for example, prefer a spot near a lake or in the mountains. Each spot is identified internally by the system using a set of coordinates, which define the position of the spot on the planet 101. It will be appreciated that users may also identify the spot by assigning a name to the spot. Preferably a 3-dimensional (x, y, z,)-coordinate system is used. The x- and y-coordinate define the position of a spot in an area 102, relative to a xy-grid superimposed on the area 102. The z-coordinate defines the area 102 the spot is in. Each area on the planet 101 is referred to by a unique z-coordinate. Alternatively a 2-dimensional x,y-grid covers the whole planet 101 in a way similar to the longitude-latitude coordinates used for defining positions on earth.

Stored in association with a spot is personal information of the owner of the spot, such as information about the life of the user of the system. Such information may, for example, comprise birth date, birth place, marital history, education profile, hobby descriptions, job descriptions, favorite quotes, favorite music or TV programs, and much more. The information may, for example be available as plain text, pictures, audio fragments or video fragments. In an alternative embodiment a spot may be occupied by multiple users, for example, a married couple (and thus the spot is associated with personal information of a plurality of users). Preferably, the spots are coupled through an extensive network of hyperlinks. A user's spot may be linked to the spots of friends and relatives, such as parents, children and cousins. A user's spot may also be linked to the spots of present and former classmates, colleagues or members of a user's sports clubs. This can be achieved by storing in association with a spot information on the links to other spots.

In one embodiment, different types of spots are provided in the sense that a spot has a different behavior depending on the state it is in. To this end, the system also stores for each spot the associated state the spot is in at that moment in time. Free spots 103 are still available and do not belong to a person. When a living person claims a free spot 103, the spot changes into an inactive spot 104. Inactive spots 104 belong to a certain person. The personal information associated with an inactive spot 104 at least comprises information identifying the person it belongs to (e.g., the name of the person), but may further comprise some information, which is provided by the user during the process of claiming the spot. An inactive spot 104 may be edited by the user it belongs to, to extend the amount of personal information of the user. As soon as the information in an inactive spot 104 is made publicly available, the inactive spot changes into an active spot 105. An alternative embodiment of the system does not comprise inactive spots 104. In such an embodiment, each spot is directly made publicly available after it has been claimed by a living person. While living, it is preferred that a user may change the contents of his or hers active spot 105 at any time.

After dying the active spot 105 changes into a closed spot 107. A closed spot 107 comprises the information about the deceased person, which was publicly available at the moment the person died. Additionally the closed spot 107 may comprise some information about the death of the person. Such information may comprise, the day of death, the cause of death and information about the burial place of the person. The system may enable the owner of the spot to have already provided other information that is only made available upon death of the person. It is preferred that the information in a closed spot 107 can not be changed, although for some reasons, it may sometimes be possible to alter the information in a closed spot 107. For example, a person has provided highly offensive material. In such a case, it is preferred that an operator of the system can remove/change the offensive material.

A fifth type of spot is a spot option 106. A spot option 106 can be granted to a user of the system, for enabling future use of a certain spot by, e.g. a friend or relative of the user. A spot option 106 may also be used for enabling a user to move from the user's spot to the spot the option is on. A spot option 106 may also be granted to a person who wants to become a user of the system. In an alternative embodiment, the system does not comprise spot options 106. In a further alternative, a distinction is made between spots for which the user has already paid and spots for which not has been paid. Such distinction may be made in any suitable way. For example, the inactive spot 104 may come in two types: inactive-not paid and inactive-paid. An inactive-not paid spot is preferably not editable by the user, whereas an inactive-paid spot is editable.

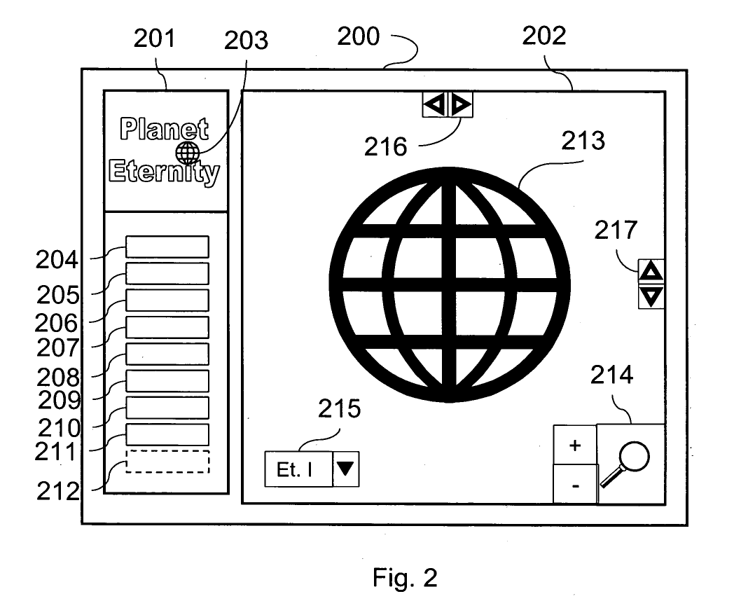

FIG. 2 shows an example of a start page 200 for a system according to one embodiment. The start page may be part of the World Wide Web or some other public worldwide communication system. The start page 200 is a starting point for a visitor or user, interested in visiting spots on the planet 101 and reading, looking at, or listening to the information comprised in the spots. The start page 200 is also a starting point for users who want to edit the contents of their own spot or visitors who are interested in claiming a spot. The start page 200 comprises two frames 201 and 202. The navigation frame 201 comprises navigation buttons 203-212. Options are associated with each navigation button 203-212. When a navigation button 203-212 is pushed, the content in the content frame 202 changes according to the option associated with the pushed navigation button 203-212. Some examples of navigation buttons 203-212 are:
A HOME-button 203 comprising a system logo, at all times, brings the visitor or user back to the start page 200.
A SEARCH-button 204 leads to a search menu, which can be used for easily finding certain spots or areas. The search menu, for example, enables searching for: a spot located at a specific set of coordinates, ten spots located near a specific set of coordinates, the hundred most recently activated spots, the hundred most recently updated spots, spots of people who are born in a specific year, spots of people from a specific country, all free spots in a specific area, spots of people with a certain surname, all areas comprising high mountains, and much more.
An AREA-button 205 leads to an area menu comprising an overview of all available areas 102 on the planet 101. The area menu enables the visitors and users to get information about all areas. Furthermore, a search option may be part of the area menu, enabling the visitor or user to search for a specific area or to search for areas with specific properties. Possibly the planet 101 is part of a bigger universe (virtual space) comprising several planets. In the event of multiple planets, the AREA-button 205 may replaced by an AREA/PLANET-button or an extra PLANET-button may be added to the navigation frame 201.
A QUOTES-button 206 leads to a quotes page, comprising an overview of, the hundred most recently added quotes and enables direct navigation to the spots comprising said quotes. The overview may comprise only quotes of active spots, only quotes of closed spots or quotes of both active and closed spots.
An ABOUT-button 207 leading to an information page, comprising, e.g., information about the system, guarantees concerning the eternal existence of the system and the terms of use for the system.
A HELP-button 208 leading to a Frequently Asked Questions (FAQ) page and contact information, such as telephone numbers and e-mail addresses of a helpdesk.
A TESTIMONIALS-button 209 leading to stories of satisfied users of the system.
A SHOWCASES-button 210 leading to examples of interesting active or closed spots.
A LOGIN-button 211 for enabling users of the system to edit their own spots, while protecting the spots from being edited by non-authorized persons. After login the LOGIN-button 211 may be changed into a MY SPOT-button, for enabling the user to quickly navigate to his or hers own spot.
One or more additional buttons 212 for various additional options.
   The content frame 202 of the start page comprises a 2D representation 213 of the planet 101. This representation 213 may be a model of a spherical planet 101, only showing half of the planet's surface because the backside of the planet 101 is hidden from the viewing point. The representation 213 may also be a flat map of the planet. When the representation 213 is a flat map, the whole surface of the planet 101 or only part of it may be visible, depending on the zoom level. Some larger areas 102 may be visible in the representation 213 at the start page 200 of the system. Zooming means 214 are provided for enabling zooming in on part of the planet 101 and for revealing smaller areas 102. When multiple planets are provided, zooming out will result in revealing more planets. In general, zooming out will result in an improved overview over the planet or planets, zooming in will result in a higher detail level. Zoom functions for navigating through maps with different levels of detail are well known from websites and computer programs for route planning. At the higher detail levels, the representation 213 may be a 3-dimensional environment as used in many computer games. Navigation through a 3D environment may be realized from a first person perspective, like in computer games as Doom™ or Quake™. If technically possible the planet 101 or the areas 102 may be represented by a full 3-dimensional virtual reality representation.

Planet selection means 215 may be provided for enabling a visitor or user to choose different planets to explore.

Horizontal navigation means 216 and vertical navigation means 217 may be provided for enabling scrolling through the 2D representation 213 of the planet 101. When the representation 213 is a model of a spherical planet 101, scrolling will result in rotation of the sphere, thereby revealing hidden parts of the planet surface.

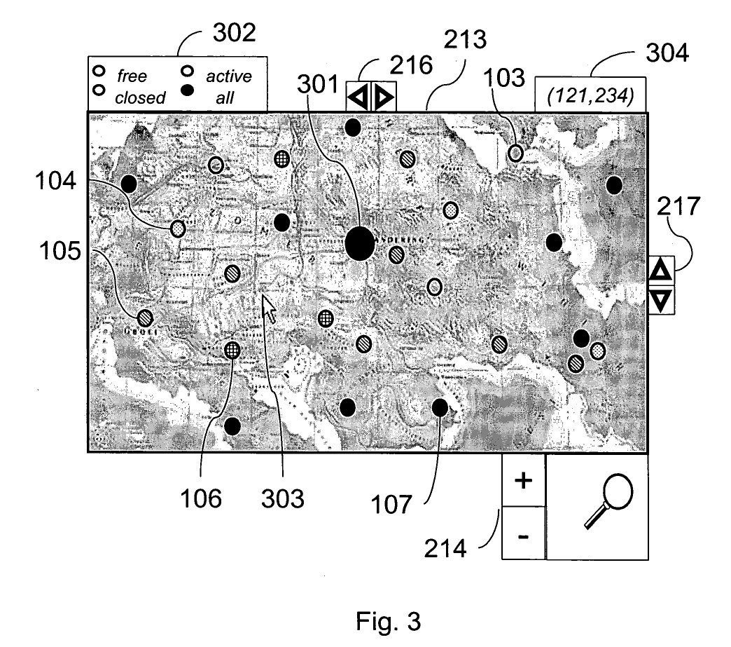

After zooming in at the planet surface, the detail level of the representation 213 of the planet 101 rises. An example of a webpage for use in the content frame 202, occurring after zooming in on the planet representation 213 several times, is shown in FIG. 3. At the detail level of the area representation 213 shown in FIG. 3, individual spots are visible. Instances of all five types of spots, shown in FIG. 1, are present in the area shown in FIG. 3. In this embodiment, all spots have a certain brightness level. Brighter spots are already visible at lower zoom levels. Darker spots are only visible at the highest zoom levels. Brighter spots may only be available for some special people, for example pop stars, politicians or Olympic champions or may be priced higher than darker spots. In an alternative embodiment, a visitor or user may define their own groups of people with brighter spots. Such groups may be formed based on specific criteria, and/or people may be added to and removed from such groups manually. A visitor or user may, for example, decide to brighten the spots of his or hers relatives and friends. At detail levels where spots with different brightness levels are visible, the brighter spots may look different from the darker spots. Brighter spots may, for example, be larger, blinking or differently shaped or colored. An example of a brighter spot 301 is shown in FIG. 3.

A spot display menu 302 enables the visitor or user to choose whether to show only free, active or closed spots or to show all types of spots. When a user is logged in, the user's spot options 106 and inactive spots 104 are shown as well. The zooming means 214 and the horizontal and vertical navigation means 216 and 217, described before are included in the web page of the area map for enabling navigation through the area. In this embodiment, a pointer 303, controlled by a pointer device, such as a mouse, a trackball, or a joystick can be used for pointing at and clicking on a spot. A position indicator 304 shows the position of the pointer 303 relative to the x,y-grid superimposed on the area 102. Clicking at a spot changes the content of the content frame 202 to the web page of the spot with the corresponding coordinates. Alternatively, the web page of the spot is opened in a new window and the content of the content frame 202 is not changed.

The layout of the web page of a spot depends on the type of spot the web page represents. The web page for a free spot 103 comprises information about the planet and the area the spot is in, information about the spot location itself, information about how to claim a free spot and means for actually claiming the free spot 103. The web page of an inactive spot 104 is only available to the user the spot belongs to and comprises means for enabling the user to edit the contents of the web page and means for activating the spot. The web page of a spot option 106 is only available to the user the spot belongs to and comprises means for definitely claiming the spot or dropping the option on the spot. After definitely claiming a spot option 106, the spot turns into an inactive spot 104. After dropping the option on a spot, the spot becomes a free spot 103.

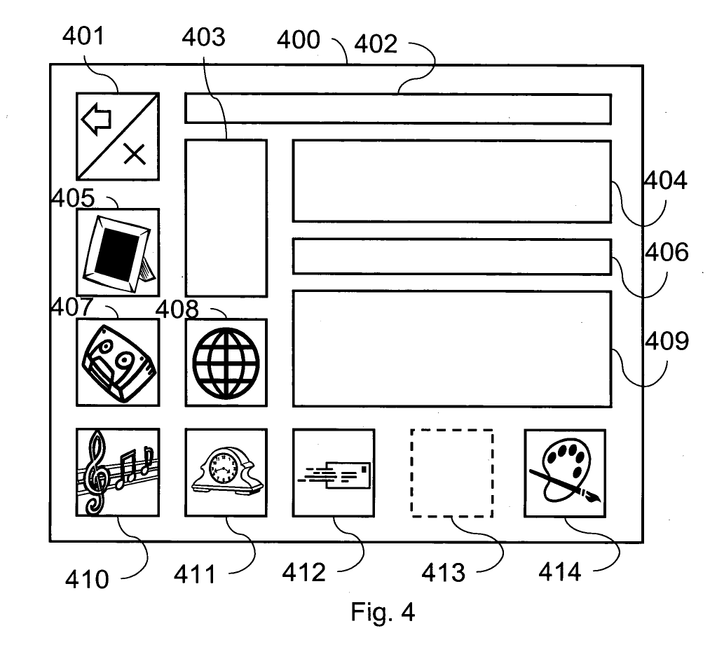

FIG. 4 shows an example of a web page 400 for an active 105 or closed spot 107. If the web page 400 is opened in a new window, the GO-button 401 closes the new window. If the web page is opened in the content frame 202 the GO-button brings the area representation 213 back in the content frame, leaving the spot's web page. The web page 400 comprises, for example, a title label 402 for displaying a name or title of the spot, a photo location 403 for displaying a photograph of the user of the spot and a facts location 404 comprising factual information about the user of the spot. Such factual information may comprise name, birth date, birth place, nationality, education level, and much more. If the web page 400 is a web page for a closed spot 107, also a dying date and other factual information concerning the death of the spot's user may be included.

A quote location 406 comprises a favorite quote of the spot's user. A text box 408 may comprise a short statement of or text about the spot's user. A picture button 405 is provided for enabling opening a photo album, comprising a collection of pictures, selected by the spot's user. A video button 407 is provided for enabling showing a collection of video fragments, selected by the spot's user. A links button 408 is provided, for offering a set of links to spots of, for example, relatives and friends of the spot's user. Also links to, for example, a list of spots of students of the schools the spot's user has attended may be provided. An audio button 410 is provided for enabling showing a collection of audio fragments, selected by the spot's user. If the web page 400 is a web page for an active spot 105, an e-mail button 412 is provided for enabling a visitor to mail the spot's user. A mail form may be used for enabling a visitor to send an e-mail without knowing the e-mail address of the spot's user. Additional buttons 412 may be provided for providing various additional functions. If the web page 400 is a web page for an active spot 105 an edit button 414 is provided for enabling the spot's user to enter an edit menu in a new window. The edit menu is a web page comprising means for editing the contents of the user's spot. Such edit menus are well known from, for example, content management systems for web pages.

The edit menu further comprises means for enabling changing the active spot 105 into a closed spot 107, after the spot's user has died. The web page 400 of a closed spot 107 may have a different look as an active site. This may be accomplished by, for example using different font types, background colors or table borders. An active spot 105 may comprise information, which is not published on the spot's web page 400 during the life of the spot's user. When the spot is closed, such ‘secret’ information is made public.

The conversion to a closed spot may be performed by a person who has been instructed by the spot's user to do so after the spot's user has died. Because of the huge consequences of a person being declared dead, the conversion preferably comprises several steps, between which several warnings may be provided. Such steps may include calling a helpdesk and requesting a sealed conversion letter with special codes needed for the conversion or entering special passwords thought up and written down by the spot's person. Preferably some verification step is included in the conversion process requiring the showing of some official document, proving the death of the spot's user.

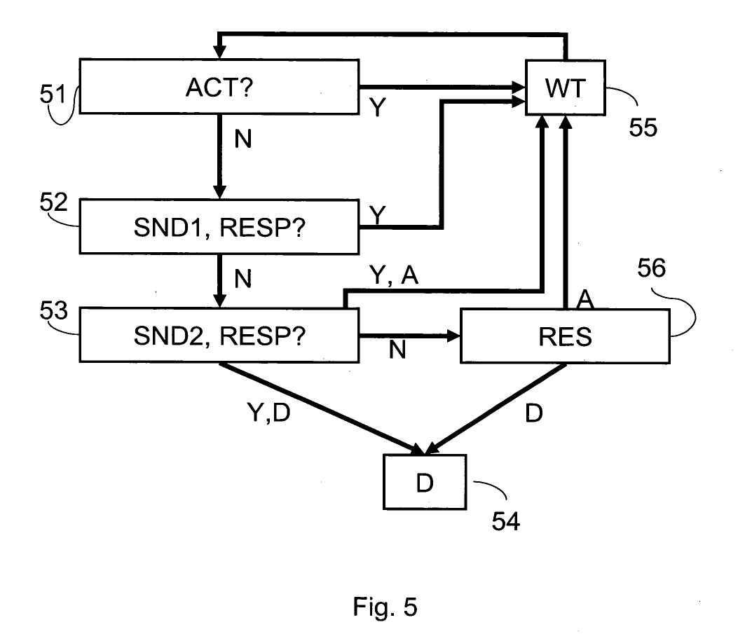

In the case that no person is instructed to make the conversion, the conversion has to be performed by the system. An example of a method for determining if a user is already dead is shown in FIG. 5. At an IS ACTIVE step 51 the systems checks whether a predetermined period (e.g., two years have passed) since the last sign of life coming from the spot's user. Signs of life are, for example, editing of the spot, logging into the system or sending of e-mails by the spot's user or a relative or friend of the spot's user, confirming that the spot's user is still alive. If the last sign of life is dated less than the predetermined period ago, the spot's user is supposed to be alive and the system waits a certain period, for example six months, at a WAIT step 55 until the IS ACTIVE step 51 is performed again. If the last sign of life is dated more than the predetermined period ago a first e-mail is sent to the spot's user, at a MAIL USER step 52, asking the spot's user to respond to the e-mail if he or she is still alive. If the spot's user responds to this first e-mail, he or she is still alive and the system proceeds to the WAIT step 55. If the spot's user does not respond to the first e-mail, he or she may have died, but a lot of other explanations can be given for the fact that the spot's user does not respond. The spot's user may, for example, have changed his or hers e-mail address, or may simply have forgotten to respond. To find out why the spot's users did not respond to the first e-mail, a second e-mail is sent to a friend or relative of the spot's user in a MAIL CONTACT step 53. The e-mail address of the friend or relative is provided to the system by the spot's user at the moment he or she claims or activates a spot. If the friend or relative of the spot's user responds to the second e-mail, the response can contain two different messages. The spot's user is either dead or alive. If the spot's user is still alive, the system proceeds to the WAIT step 55. If the spot's user is dead, the system closes the spot at CLOSE SPOT step 54.

In the event that the friend or relative does not respond to the second e-mail, some extra research is done at RESEARCH step 56, in order to find out if the spot's user is still alive. Such research may comprise calling the spot's user or a friend or relative by phone, visiting the spot's user or a friend or relative at home and searching official registers. If the research shows that the spot's user is dead, the system closes the spot at CLOSE SPOT step 54. If the research shows that the spot's user is still alive, the system proceeds to WAIT step 55. In a preferred embodiment, the owner of a spot can compile/provide the enquiry e-mail to the friend or relative and this email is stored in association with the spot.

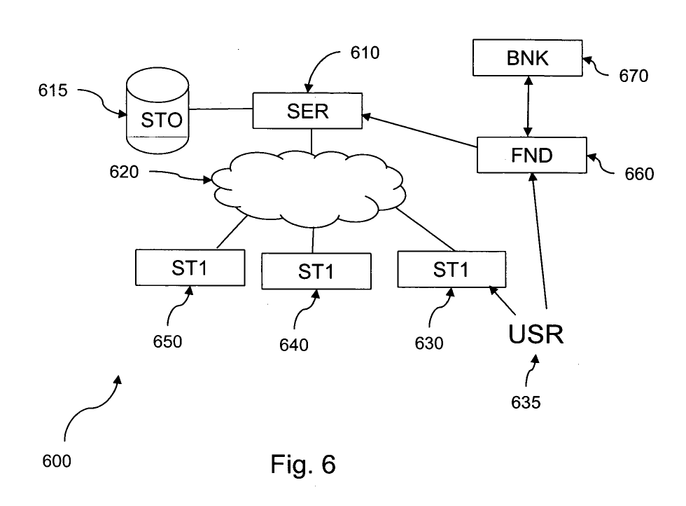

FIG. 6 shows a block diagram of an embodiment of a system 600 according to one embodiment. The system 600 includes a server 610 and a plurality of stations (shown are stations 630, 640, and 650). The server 610 and stations 630, 640, 650 are able to communicate through a world-wide network 620. At this moment, such a network is preferably based on Internet. It will be appreciated that also other wide area communication systems may be used.

The server 610 and stations 630, 640, 650 are equipped with suitable hardware and software for such communication. Such communication hardware and software is well-known and will not be described in detail here. The communication network may include any communication medium, such as the Internet backbone, broadband networks/dial-in connections, and wired or wireless local area networks. The server 600 may be implemented in any suitable way, for example based on a computer platform as is commonly used for Internet servers and loaded with a suitable program. Such program may be stored on a background storage, such as a hard disk or optical storage medium, and during execution loaded in a faster memory, such as RAM.

The stations 630, 640, 650 may be implemented in any suitable way, for example based on a personal computer platform as is commonly used for Internet clients and loaded with a suitable program. Such program may be stored on a background storage, such as a hard disk or optical storage medium, and during execution loaded in a faster memory, such as RAM. The station may also be a mobile, hand-held device, such as a PDA or based on an advanced mobile telephone platform.

The server 610 includes a storage 615 for storing a graphical 2 or 3-dimensional area and graphical representations of a plurality of spots on the area. The same or other storage is also used for storing personal information of a user in association with a spot ‘owned’ by the user as described in more detail above. In the example of FIG. 6, station 630 is used by a user 635 that claims a spot and provides personal information for it. Stations 640 and 650 are used by users browsing through the spots and accessing personal information stored for closed spots.

A processor (not shown) in the server 610 can be loaded with a program so as to providing to a client station the graphical 2 or 3-dimensional area and graphical representations of the spots. This downloading may occur on the initiative of the client station 630. The processor can also control that the server 610 receives from the client station 630 information that a user 635 has selected and claimed a spot on the area and also receives personal information of the user 635. The processor then ensures that the received personal information is stored in the storage 615 in association with the claimed spot. More details of a possible user interface and interaction between the server and client station 630 have already been described with reference to FIGS. 1, 2 and 3.

The client station 630 including a user interface (not shown) for interaction with a user. Such a user interface includes a display (e.g. LCD) and means for receiving input from a user (e.g. mouse, keyboard, etc.). The client station 630 also includes a processor (not shown) for, under control of a program, obtaining from the server the graphical 2 or 3-dimensional area and graphical representations of the spots. The processor then controls displaying of the area and spots to the user. The processor also ensures that the user can select a spot displayed on the area, claim a selected spot, and provide personal information in association with the claimed spot. The processor also ensures that the personal information is provided to the server 610 in association with the claimed spot.

The browsing stations 640, 650 also include a user interface and a processor. Under control of a program, the processor ensures that from the server the graphical 2 or 3-dimensional area and graphical representations of the spots are obtained and that the area and spots are displayed to the user. The processor also enables a user to browse through claimed spots on the area, to select a claimed spot and to obtain from the server personal information stored in association with the spot and to render the obtained personal information.

It will be appreciated that in addition to the graphical interface also the programs executed by the client stations may be downloaded from the server 610. Instead of using a web browser controlled via a downloaded web page (e.g. in HTML or XML format), also an executable program may be downloaded. Such a program may be for a virtual machine, such as Java, or may be directly executable. The graphical interface may also be obtained by such a downloaded program.

In a preferred embodiment, the method and system can also supply personal information long after the user has died. Preferably, such information is maintained and published indefinitely. To this end, the money paid by the user 635 is preferably split into at least two parts. A first part is used for administrative purposes such as registering the new user, issuing certificates with a secure identity of the user, etc. A second part is invested. Part of the return on the investment is used for paying for keeping the server on-line and keeping all hardware and software of the system up-to-date. In this way, a system can be kept that stores and publishes personal information of the user after the user has deceased.

Preferably, the user 635 pays to an independent company, such as a foundation, monitored by well-respected supervisors. The money is not directly handed-over to a company that operates the actual system. Instead, a regular flow of money (obtained from the investments) is used to pay the company (or companies) that actually operate the system. Preferably, the independent company 660 also regularly obtains a back-up of all information stored in the system, including all programs used in the system. In this way, it can be ensured that even after a major financial problems at an operating company, the service offered by the system can be quickly restarted.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device/system claims enumerating several means, several of these means may be embodied by one and the same item of hardware. The mere fact that certain measures are recited in mutually different dependent claims does not indicate that a combination of these measures cannot be used to advantage.

1. A method of enabling users to make personal information available through a public world-wide communication system; the method comprising the steps of:
presenting the user an easy and intuitive user interface;
enabling the user to fill in his personal information; and
enabling other people to have access to said personal information through said easy and intuitive user interface.

2. A method according to claim 1, wherein said user interface presents a 2 or 3 dimensional virtual landscape, enabling the user to select a spot in said landscape and to store personal information in association with the selected spot.

3. A method according to claim 1, the method including investing a part of money paid by a user for access to the system and using a return on the investment for paying for keeping and maintaining said personal information of the user after the user has deceased.

4. A method according to claim 1, wherein said personal information is comprised in a predetermined fixed format.

5. A method according to claim 1, wherein said personal information comprises information in different data formats.

6. A method according to claim 1, wherein said personal information comprises text, pictures, moving images and sound.

7. A method according to claim 1, further comprising providing the possibility of keeping and maintaining said personal information long after the user has deceased.

8. A method according to claim 7, wherein said user interface presents a 2 or 3 dimensional virtual landscape, enabling the user to select a spot in said landscape and to store personal information in association with the selected spot.

9. A method according to claim 7, wherein keeping and maintaining said personal information comprises converting said personal information to newly developed data formats.

10. A method according to claim 7, the method including investing a part of money paid by a user for access to the system and using a return on the investment for paying for keeping and maintaining said personal information of the user after the user has deceased.

11. A method according to claim 10, wherein said user interface presents a 2 or 3 dimensional virtual landscape, enabling the user to select a spot in said landscape and to store personal information in association with the selected spot.

12. A communication system for making personal information of a user available to other users; the system including a server and a plurality of client stations arranged for communication through a world-wide communication network; the server comprising:
means for displaying an easy and intuitive user interface to the user;
means for receiving personal information from the user in the form of text, pictures, sound and moving images; and
means for keeping and maintaining said personal information long after the user has deceased.

13. A communication system according to claim 12, wherein said user interface presents a 2 or 3 dimensional virtual landscape, enabling the user to select a spot in said landscape and to store personal information in association with the selected spot.

14. A communication system according to claim 12, further comprising means for enabling other people to have access to said personal information through said easy and intuitive user interface.

15. A communication system according to claim 14, wherein said user interface presents a 2 or 3 dimensional virtual landscape, enabling the user to select a spot in said landscape and to store personal information in association with the selected spot.

16. A communication system according to claim 12, wherein said personal information comprises information in different data formats.

17. A communication system according to claim 12, wherein said personal information comprises text, pictures, moving images and sound.

18. A communication system according to claim 11, wherein the means for keeping and maintaining said personal information long after the user has deceased includes investing a part of money paid by a user for access to the system and using a return on the investment for paying for keeping and maintaining said personal information of the user after the user has deceased.
